(19) United States
(12) Patent Application Publication
(10) Pub. No.: US 2022/0400664 A1
(43) Pub. Date: Dec. 22, 2022

(54) Combination Snake Catching and Killing Device

(71) Applicant: Phillip James Hernandez, Montgomery, TX (US)

(72) Inventor: Phillip James Hernandez, Montgomery, TX (US)

(21) Appl. No.: 17/354,246

(22) Filed: Jun. 22, 2021

(51) Int. Cl. A01M 27/00; B25G 1/10

(52) U.S. Cl. CPC A01M 27/00; B25G 1/10

(57) ABSTRACT

A combination snake catching and killing device is provided. The device includes an elongated hollow body configured to house a blade assembly with a blade used for dismembering a snake when fired. A handle assembly includes a handle, a charge handle configured to cock and fire the blade, and a grip lever configured to activate a gripping member with jaws that can grip a snake allowing a user to handle and/or relocate a snake or kill the snake, as necessary.

### CROSS-REFERENCE TO RELATED APPLICATION

This application claims the benefit of U.S. Provisional Patent Application No. 63/043,018, filed Jun. 23, 2020, which is incorporated by reference herein in its entirety.

### COPYRIGHT AND TRADE DRESS NOTICE

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to devices for catching and/or killing animals, and more specifically, to a device for safely catching, relocating, and/or killing snakes.

### 2. Description of Related Art

This background information is intended to further educate the reader as to additional aspects of the prior art and may present examples of specific aspects of the prior art that is not to be construed as limiting the disclosure of the present application.

Snake handling devices are known in the art and are an effective means for disposing of a snake safely. However, one common problem with current snake handling devices is the inability to optionally capture a snake without killing it or alternatively killing the snake if necessary.

People encounter snakes in a variety of situations. For example, researcher may have a need to capture a snake for research purposes. A person may encounter a snake that has wandered onto his/her property and desires to relocate the snake safely. Alternatively, a snake encountered may be particularly dangerous such as a poisonous snake and it may be necessary to kill the snake for protection. Current snake handling devices do not provide flexibility to a user to both handle a snake by either capturing it without killing it or killing it if necessary, according to the user's needs.

Accordingly, although great advances have been made in the area of snake catching and/or killing devices, there are deficiencies that remain.

### SUMMARY

The disclosure of the present application addresses the above stated deficiencies with snake handling devices. The combination snake catching and killing device of the present application is unique when compared with other known snake handling devices because it allows for a user to safely capture a live snake and handle and/or relocate it without killing it or optionally killing the snake if necessary.

The device of the present application includes an elongated hollow body with a handle end and a grip end. The handle end includes a handle assembly with a handle for a user to safely use the device. The grip end includes a grip assembly with jaws that can grasp a snake when the user actuates a grip lever. The device includes a blade assembly with a blade that the user can cock with a charge handle. While the blade is cocked and a snake is gripped, the user can propel the blade by releasing the charge handle thus dismembering and killing the snake.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view illustrating a combination snake catching and killing device in accordance with a preferred embodiment of the present application;

FIG. 2 is a cross-sectional side view illustrating the combination snake catching and killing device of FIG. 1;

FIG. 3 is a cross-sectional side view illustrating a handle assembly of the combination snake catching and killing device;

FIG. 4 is a cross-sectional side view illustrating a grip assembly of the combination snake catching and killing device;

FIG. 5 is a perspective view illustrating the grip assembly of the combination snake catching and killing device; and

FIG. 6 is a side view illustrating the combination snake catching and killing device.

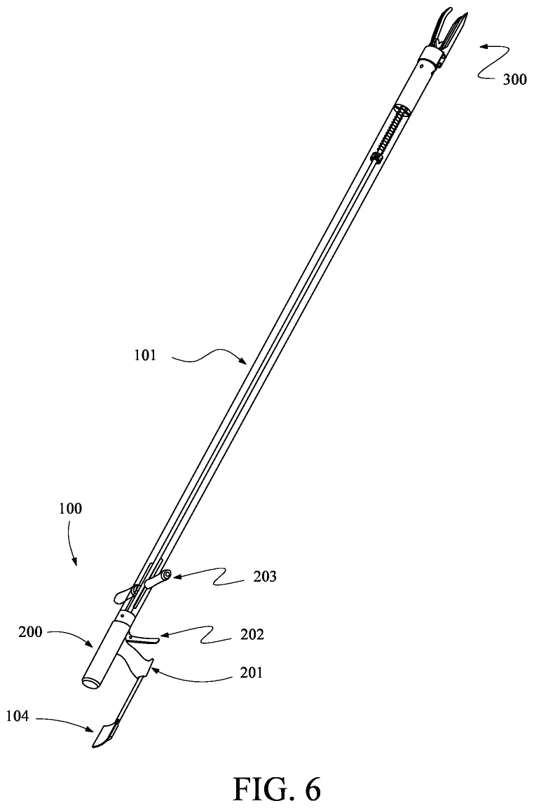

While the system of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

### DETAILED DESCRIPTION

Illustrative embodiments of the system of the present application are provided herein. It should be appreciated that in the development of any actual embodiment, various implementation-specific decisions are required to achieve the developer's specific goals, such as compliance with system-related and business-related constraints, which vary from one implementation to another. Moreover, it should be appreciated that such a development effort might be complex and time-consuming but would nevertheless be a routine undertaking for those of ordinary skill in the art having the benefit of this disclosure.

The system in accordance with the present application overcomes one or more of the above-discussed shortcomings commonly associated with conventional snake handling devices. Specifically, the combination snake catching and killing device incorporates a means for allowing a user to safely capture and handle and/or relocate a snake or optionally kill the snake if necessary. These and other unique features of the system are discussed below and illustrated in the accompanying drawings.

The system should be understood, both as to its structure and operation, from the accompanying drawings, taken in conjunction with the accompanying description. Various embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

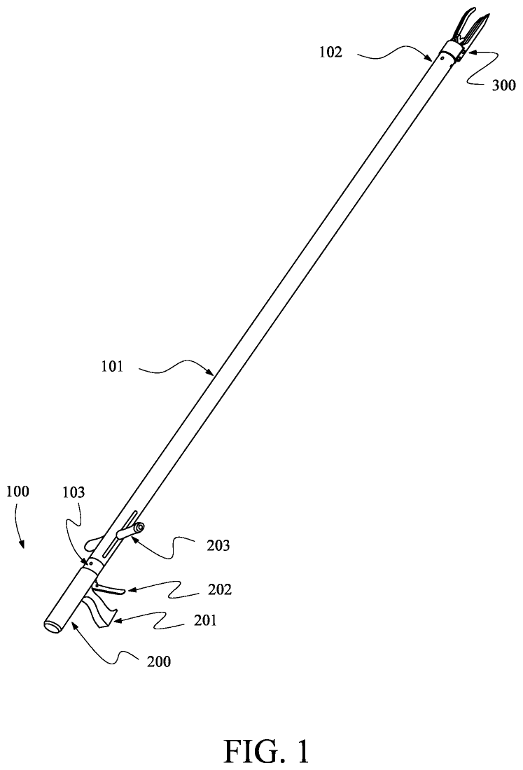

Referring now to the drawings wherein like reference characters identify corresponding or similar elements throughout the various views, FIG. 1 depicts a side view of a combination snake catching and killing device in accordance with an embodiment of the present application. The device 100 allows a user to safely handle a snake and either relocate the snake or kill the snake as needed. Device 100 has an elongated hollow body 101 with a handle end 102 and a grip end 103. Attached to the handle end 102 is a handle assembly 200. Attached to the grip end 103 is a grip assembly 300. Inside the elongated hollow body 101 is a blade assembly 400.

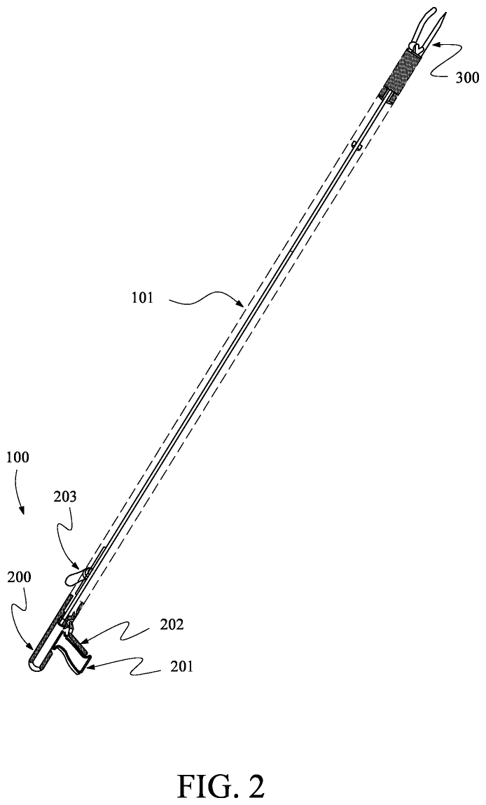

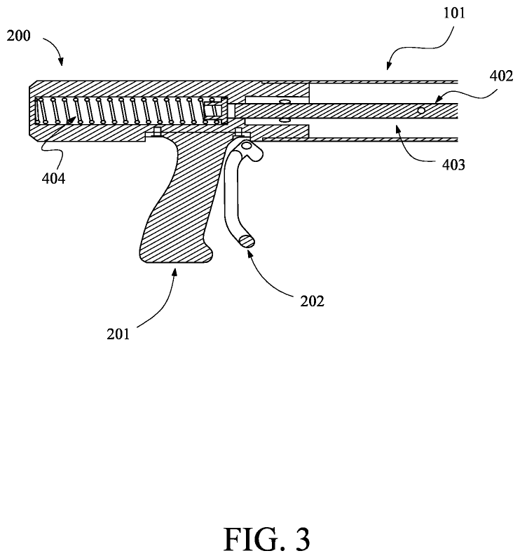

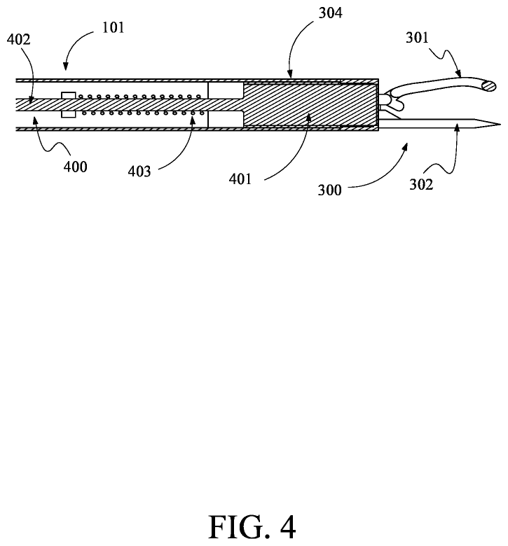

The blade assembly 400 includes a blade 401 connected to an end of a blade shaft 402, a drive spring 404 and a recall spring 403. The drive spring 404 is configured to propel the blade 401 and the recall spring 403 is configured to return the blade 401 to its neutral position. The blade assembly 400 is housed within the elongated hollow body 101 as shown in FIGS. 2-4.

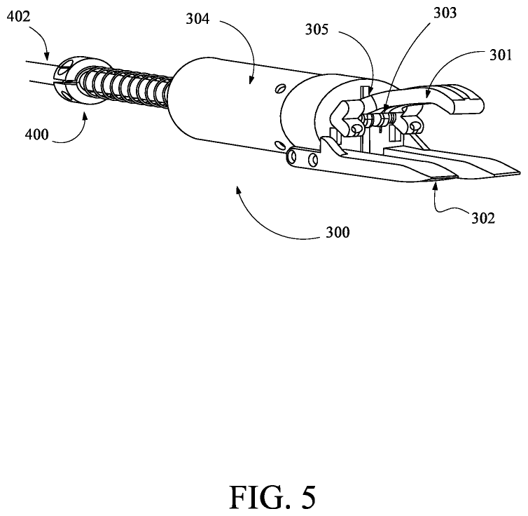

FIG. 5 shows the grip assembly 300 which includes a blade housing 304 configured to house the blade 401 while in its neutral position. A blade mouth 305 is a sufficient size wherein the blade 401 can pass through the blade mouth 305 and return to its neutral position. A gripping member is defined by a supporting jaw 302 and an actuating jaw 301. The supporting jaw 302 is attached to a lower portion of the grip assembly 300 and the actuating jaw 301 is connected at a point by a jaw fastener 303 where the actuating jaw 301 is configured to rotate about the point.

The supporting jaw 302 may include an aperture wherein the actuating jaw 301 passes through the supporting jaw 302 when the gripping member is activated by the user. The actuating jaw 301 passing through the supporting jaw 302 may facilitate capturing snakes of varying sizes allowing the user to secure the snake without the snake escaping.

The handle assembly 200 includes a handle 201 that the user can conveniently and comfortably grip with his/her hand and operate device 100. The handle assembly 200 further includes a charge handle 203 configured to cock the blade assembly 400. Once the blade assembly 400 is in a cocked position, the user may release the charge handle 203 and the blade 401 is propelled through the blade mouth 305 dismembering a snake held by the gripping member. A grip lever 202 is connected to the handle assembly 200 and configured to activate the gripping member by rotating the actuating jaw 301 and gripping a snake.

The charge handle 203 may include one or more hand grips to facilitate cocking the blade assembly 400 from either side of the device 100 allowing the user to operate the device 100 with either hand. The grip lever 202 may be activated by the user's free hand or the user's hand that is gripping the handle 201. The grip lever 202 may include a locking mechanism to hold the jaws in a closed position without requiring the user's manual input. This allows the user to rest and grip the snake continuously without getting fatigued which is useful for handling a snake for long periods of time that may need to be relocated a great distance.

It should be appreciated that the user may activate the grip lever 202 to capture a snake between the jaws of the gripping member while keeping the snake alive. This is convenient if the user desires to handle the snake or relocate the snake without killing it. After a snake is captured with the gripping member, the user may elect to activate the charge handle 203 cocking the blade assembly 400 and dismembering and killing the snake upon release of the charge handle 203. The grip member may be configured to allow rotation of both the actuating jaw 301 and the supporting jaw 302 relative to each other. Additionally, device 100 may include a trigger mechanism such that the blade assembly 400 may be cocked into a cocked position such that the user may fire the blade 401 by activating the trigger mechanism while the blade assembly 400 is in the cocked position.

The elongated hollow body 101 may be configured to receive various components and accessories that might assist the user in operating the device 100. For example, the user may connect a light source to the device 100 to facilitate the use of device 100 at night or in other locations with limited visibility. Additionally, an arm support member 104 may be attached to the handle 201 to provide additional comfort and support to the user. The arm support member 104 may also provide additional support necessary to handle larger snakes. The various components of device 100 are made from a suitable material that provides durability and strength as necessary for handling snakes of varying sizes.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. A combination snake catching and killing device, comprising:
an elongated hollow body having
a handle end; and
a grip end;
a blade assembly disposed within the elongated hollow body, the blade assembly including
a blade shaft;
a blade attached to the blade shaft;
a drive spring configured to propel the blade; and
a recall springs configured to return the blade to a neutral position;
a grip assembly disposed on the grip end of the elongated hollow body, the grip assembly including
a blade housing wherein the blade is housed within the blade housing while in the neutral position;
a blade mouth wherein the blade passed through the blade mouth upon firing; and
a gripping member defined by a supporting jaw and an actuating jaw
wherein the actuating jaw is attached at a point by a jaw fastener and configured to rotate about the point;
a handle assembly disposed on the handle end of the elongated hollow body, the handle assembly including
a handle configured to be held by a hand of a user;
a charge handle configured to cock and release the blade assembly;
a grip lever configured to engage the gripping member by rotating the actuating jaw about the point.

2. The snake catching and killing device of claim 1, wherein the charge handle includes one or more hand grips.

3. The snake catching and killing device of claim 1, wherein the actuating jaw passes through the supporting jaw to facilitate gripping snakes of varying sizes.

4. The snake catching and killing device of claim 1, further comprising a grip lever locking mechanism configured to hold the gripping member in a closed position without requiring manual input from the user.

5. The snake catching and killing device of claim 1, further comprising an arm support member attached to handle.

6. The snake catching and killing device of claim 1, wherein the supporting jaw is configured to rotate relative to the actuating jaw when activated by the grip lever.

7. The snake catching and killing device of claim 1, further comprising a blade locking mechanism configured to prevent movement of the blade.
